(19) United States
(12) Patent Application Publication
(10) Pub. No.: US 2008/0232132 A1
(43) Pub. Date: Sep. 25, 2008

(54) Low-absorptive diffuser sheet and film stacks for direct-lit backlighting

(75) Inventors: John F. Graf, Ballston Lake, NY (US); Dennis J. Coyle, Clifton Park, NY (US); Eugene Olczak, Pittsford, NY (US); Philip Peters, Mt. Vernon, IN (US); Masako Yamada, Niskayuma, NY (US)

Correspondence Address: FOLEY AND LARDNER LLP;SUITE 500, 3000 K STREET NW, WASHINGTON, DC, 20007, US

(73) Assignee: General Electric Company

(21) Appl. No.: 11/723,891

(22) Filed: Mar. 22, 2007

(51) Int. Cl. F21V 7/04; G02B 5/02

(52) U.S. Cl. 362/608; 359/599

(57) ABSTRACT

There is provided an optical diffuser sheet. The optical diffuser sheet has a first surface and a second surface opposite to the first surface. The first surface has a plurality of optical structures arranged to diffuse and direct light illuminated onto the first surface. The optical diffuser sheet when illuminated is characterized by an absorption of less than 10% and an absolute hiding power of less than 10%.

### BACKGROUND OF THE INVENTION

This invention relates to diffuser sheets, and display assemblies incorporating such diffuser sheets.

A backlight illuminates a liquid crystal (LC) based display panel to provide light distribution over the entire plane of the LC display (LCD) panel. Typical direct-lit LCD backlights consist of individual fluorescent lamps placed in a reflecting cavity to directly shine light upwards towards and through the LCD panel.

A typical direct-lit LCD backlight has a diffuser sheet to hide the individual lamps. The diffuser sheet is typically filled with light-scattering particles, has a transmission of only about 55% and a haze of over 99% to drastically scatter the light so that the individual lamps cannot be seen. On top of the diffuser sheet is a “bottom diffuser” that is typically a plastic film coated with spheres and a binder, which aids in hiding the bulbs, but also turns or collimates the light somewhat in the direction of the viewer. Often a prism film is arranged on the diffuser sheet, where the prism film has prisms running in a horizontal direction (direction parallel to the orientation of the lamps) to collimate the light strongly in the vertical direction (direction in the plane of the prism film and perpendicular to the horizontal direction). Typical applications for direct-lit backlights are in televisions, where it is acceptable to collimate the light vertically since viewers typically do not view from above or below the screen, while it is typical to not collimate horizontally since it is common to view the screen from side angles.

### SUMMARY OF THE INVENTION

One aspect of some embodiments of the present invention is to provide an optical diffuser sheet, and optical display assembly incorporating the sheet, that provides enough light-scattering to hide the individual light sources of a light provider from a viewer and provides relatively uniform diffuse light. Another aspect of some embodiments of the present invention is to provide an optical diffuser sheet, and optical display assembly incorporating the sheet, that directs light preferentially towards the viewer on-axis.

According to one embodiment of the invention there is provided an optical diffuser sheet. The optical diffuser sheet comprises: a first surface having a plurality of optical structures arranged to diffuse and direct light illuminated onto the first surface, wherein the optical structures have a concave cross-section; and a second surface opposite to the first surface.

According to another embodiment of the invention there is provided an optical diffuser sheet. The optical diffuser sheet comprises: a first surface having a plurality of optical structures arranged to diffuse and direct light illuminated onto the first surface, wherein the optical structures have a sinusoidal wave cross-section; and a second surface opposite to the first surface.

According to another embodiment of the invention there is provided an optical diffuser sheet. The optical diffuser sheet comprises: a first surface having a plurality of optical structures arranged to diffuse and direct light illuminated onto the first surface, wherein a shape and dlimensions of each optical structure represents a random modulation of a corresponding idealized structure; and a second surface opposite to the first surface.

According to another embodiment of the invention there is provided an optical diffuser sheet. The optical diffuser sheet comprises: a first surface having a plurality of optical structures arranged to diffuse and direct light illuminated onto the first surface; and a second surface opposite to the first surface, wherein the optical diffuser sheet when illuminated is characterized by an absorption of less than 10% and an absolute hiding power of less than 10%.

According to another embodiment of the invention there is provided an optical display assembly. The optical display assembly comprises: a light provider comprising a plurality of light sources; an optical diffuser sheet comprising: a first surface having a plurality of optical structures arranged to diffuse and direct light illuminated onto the first surface from the light provider; and a second surface opposite to the first surface; and a diffuser film over the light provider and optical diffuser sheet, arranged to receive light from the optical diffuser sheet, the diffuser film having a density of light scattering particles to provide light diffusion and/or a rough surface to provide light diffusion.

According to another embodiment of the invention there is provided an optical display assembly. The optical display assembly comprises: a light provider comprising a plurality of light sources; an optical diffuser sheet comprising: a first surface having a plurality of optical structures arranged to diffuse and direct light illuminated onto the first surface from the light provider, wherein a shape and dimensions of each optical structure represents a random modulation of a corresponding idealized structure in a vertical direction; and a second surface opposite to the first surface; and an optical film arranged on the optical diffuser sheet adjacent to the first surface.

According to another embodiment of the invention there is provided an optical display assembly. The optical display assembly comprises: a light provider comprising a plurality of light sources; a first optical diffuser sheet comprising: a first surface having a plurality of optical structures arranged to diffuse and direct light illuminated onto the first surface from the light provider; and a second surface opposite to the first surface, and having a plurality of optical structures arranged to diffuse and direct light illuminated onto the second surface; and a second optical diffuser sheet arranged above the first optical diffuser sheet comprising: a third surface having a plurality of optical structures arranged to diffuse and direct light illuminated onto the third surface; and a fourth surface opposite to the third surface.

According to another embodiment of the invention there is provided an optical display assembly. The optical display assembly comprises: a light provider comprising a plurality of light sources; an optical diffuser sheet comprising: a first surface having a plurality of optical structures arranged to diffuse and direct light illuminated onto the first surface from the light provider; and a second surface opposite to the first surface, and having a plurality of optical structures arranged to diffuse and direct light illuminated onto the second surface; and a light collimating diffuser film arranged above the optical diffuser sheet.

According to another embodiment of the invention there is provided an optical display assembly. The optical display assembly comprises: a light provider comprising a plurality of light sources; an optical diffuser sheet comprising: a first surface having a plurality of optical structures arranged to diffuse and direct light illuminated onto the first surface from the light provider; and a second surface opposite to the first surface; and a light collimating diffuser film arranged above the optical diffuser sheet.

### BRIEF DESCRIPTION OF THE DRAWINGS

FIG. 1 is a schematic perspective view of an optical display assembly with optical diffuser sheet according to an embodiment of the invention.

FIG. 2 is a perspective view of a diffuser sheet according to an embodiment of the invention.

FIG. 3 is an illustration of a light provider 12 with light sources 32 for explaining hiding power.

FIG. 4 is a perspective view of a diffuser sheet according to an embodiment of the invention.

FIG. 5 is a perspective view of a diffuser sheet with optical structures on both sides according to an embodiment of the invention.

FIG. 6 is a cross-section of a diffuser sheet with idealized optical structures.

FIG. 7 is a perspective of a diffuser sheet with optical structures having some random modulation in the lateral direction according to an embodiment of the invention.

FIG. 8 is a perspective of a diffuser sheet with optical structures having some random modulation in a direction perpendicular to the lateral direction according to an embodiment of the invention.

FIG. 9 is a cross sectional view illustrating a convex half cylinder surface texture of a diffuser sheet according to an embodiment of the invention.

FIG. 10A is a cross sectional view illustrating a convex sinusoidal surface texture of a diffuser sheet according to an embodiment of the invention.

FIG. 10B is a cross sectional view illustrating a concave half cylinder surface texture of a diffuser sheet according to an embodiment of the invention.

FIG. 11 is a schematic perspective view of an optical display assembly with optical diffuser sheet according to another embodiment of the invention.

FIG. 12 is a schematic perspective view of an optical display assembly with optical diffuser sheet according to another embodiment of the invention.

FIG. 13 is a schematic perspective view of an optical display assembly with optical diffuser sheet according to another embodiment of the invention.

FIG. 14 is a schematic perspective view of an optical display assembly with optical diffuser sheet according to another embodiment of the invention.

FIG. 15 is a schematic perspective view of an optical display assembly with optical diffuser sheet according to another embodiment of the invention.

FIG. 16 is a schematic perspective view of an optical display assembly with optical diffuser sheet according to another embodiment of the invention.

FIG. 17 is a schematic perspective view of an optical display assembly with optical diffuser sheet according to another embodiment of the invention.

FIG. 18 is a schematic perspective view of an optical display assembly with optical diffuser sheet according to another embodiment of the invention.

FIG. 19 is a schematic perspective view of an optical display assembly with optical diffuser sheet according to another embodiment of the invention.

FIG. 20 is a schematic perspective view of an optical display assembly with optical diffuser sheet according to another embodiment of the invention.

FIG. 21 is a graph illustrating luminance as a function of view angle for both vertical and horizontal views.

FIG. 22 is a schematic perspective view of an optical display assembly with optical diffuser sheet according to another embodiment of the invention.

FIG. 23 is a schematic perspective view of an optical display assembly with optical diffuser sheet according to another embodiment of the invention.

FIG. 24 is a schematic perspective view of an optical display assembly with optical diffuser sheet according to another embodiment of the invention.

FIG. 25 is a schematic perspective view of an optical display assembly with optical diffuser sheet according to another embodiment of the invention.

FIG. 26 is a graph illustrating luminance as a function of horizontal view angle for stacks of optical components with and without an optical diffuser sheet.

### DETAILED DESCRIPTION OF THE PREFERRED EMBODIMENTS

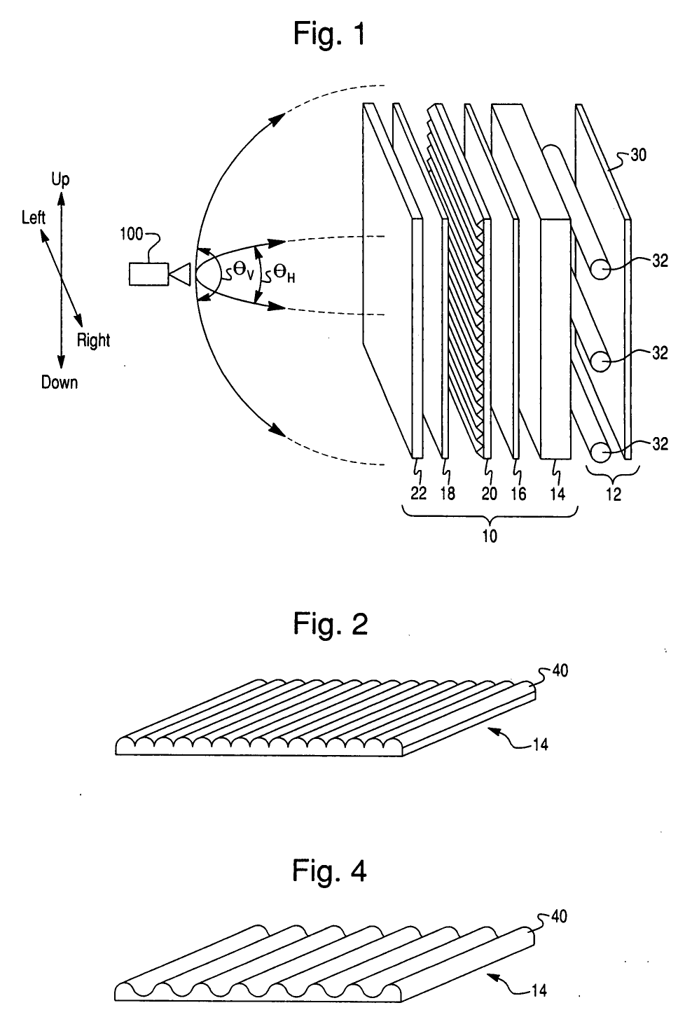

FIG. 1 is a schematic illustrating an embodiment of an optical display assembly 10. The optical display assembly includes a light provider 12, an optical diffuser sheet 14, optical films 16, 18, and 20, and liquid crystal 22.

The light provider 12 includes a reflector 30, and a number of light sources 32. The light sources may be, for example, lamps such as cold cathode florescent lamps (CCFLs). The light sources are oriented parallel to each other and along a horizontal direction from left-to-right as shown in FIG. 1. The up and down or vertical direction is a direction in the plane of the light sources 32, but perpendicular to the horizontal left-to-right direction. While FIG. 1 illustrates three light sources 32 for illustration purposes, in general, the number of light sources 32 will be much larger then three.

Prism film 20 has a number of prism structures generally parallel to each other and oriented along the horizontal direction. The prism film 20, may be, for example, composed of poly(ethylene terephthalate) having a texture coating with an array of prisms.

The diffuser films 16 and 18 have a density of light scattering particles to provide light diffusion and/or a rough surface to provide light diffusion. The diffuser films may be, for example, made of polycarbonate with 2 micron diameter particles composed of hydrolyzed poly(alkyl trialkoxysilanes) available under the trade name TOSPEARL™ from GE Silicones.

FIG. 1 also illustrates the geometry for determining the luminance as a function of zenith angle for both a horizontal view and a vertical view. A light detector 100 is oriented facing perpendicular to the plane of the light provider 12. In this position, the detector 100 may detect the on-axis luminance. The detector 100 may be rotated along an arc about an axis in the horizontal direction to determine the vertical view luminance. In this case, the detector 100 may be rotated about a vertical zenith angle θv and the luminance as a function of the vertical zenith angle θv may be obtained. The detector 100 may also be rotated along an arc about an axis in the vertical direction to determine the horizontal view luminance. In this case the detector may be rotated about a horizontal zenith angle θh and the luminance as a function of the horizontal zenith angle θh may be obtained.

The horizontal view luminance as a function of horizontal zenith angle θh provides an indication of the directional nature of the light from the optical display assembly, and thus the light directing properties for a horizontal view of the optical components in the optical display assembly. For example, if the horizontal view luminance as a function of horizontal zenith angle θh exhibits a narrow peak around a zero degree zenith (on axis), then the light for the horizontal view is well collimated. In a similar fashion, the vertical view luminance as a function of vertical zenith angle θv provides an indication of the light directing properties for a vertical view of the optical components in the optical display assembly.

FIG. 2 illustrates a diffuser sheet 14 according to one embodiment of the invention. The diffuser sheet 14 has a plurality of surface microstructures or optical structures 40 that are structured to provide both hiding power, such that the individual light sources 32 cannot be seen by an observer, and a desired directional output of light.

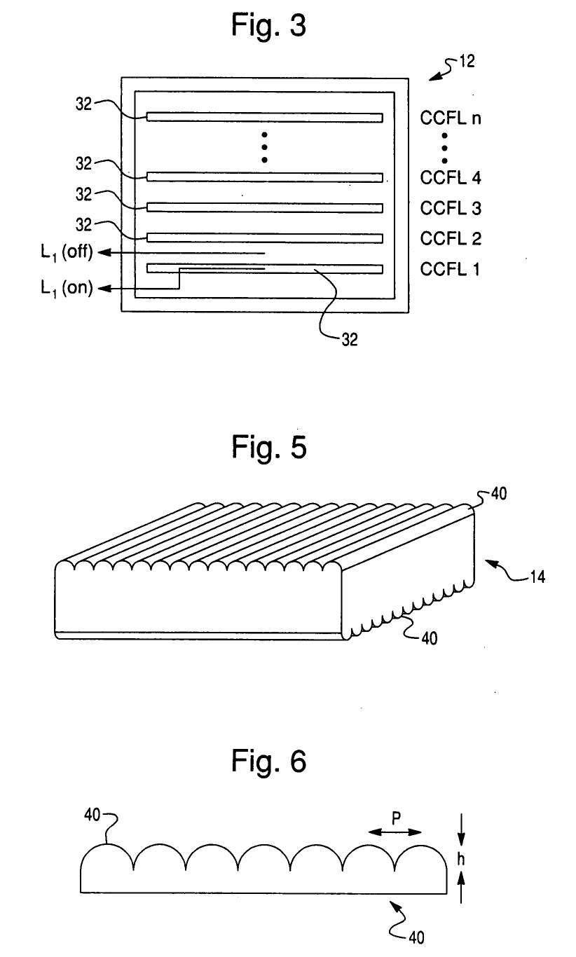

FIG. 3 is an illustration of a light provider 12 with light sources 32 (CCFLs) for explaining hiding power. The term “hiding power” as used herein refers to the ability of light diffusing films to mask the light and dark pattern produced by, for example, the light sources 32, such as the linear array of CCFLs shown in FIG. 3. Quantitatively, hiding power can be mathematically described by FIG. 3 and the following equation:

$$Hiding power ( \% ) = ( 1 - \frac{{\sum }_{i = l}^{n - 1} {L}_{i} ( on )}{{\sum }_{j = 1}^{n - 1} {L}_{j} ( off )} ) \times 100$$

where Lᵢ(on) is the luminance directly above one of the lamps, and Lⱼ(off) is the luminance directly above a midpoint between lamp j and lamp j+1, and n is the number of lamps. FIG. 3 illustrates n lamps. The luminance is measured on the side of the diffusing film opposite to the light provider 12. The point between adjacent lamps is relatively darker in comparison to a point above a lamp. Thus, in general the Lⱼ(off) values will be less than the Lᵢ(on) values, and thus the summation of the Lᵢ(on) will be greater than the summation of the Lⱼ(off). If a light diffusing film perfectly hides the lamps, then the Lⱼ(off) values will be the same as the Lᵢ(on) values, and the hiding power has a value of 0%. In general the hiding power may have a positive or a negative value. Often the value of importance for the hiding power is the absolute value of hiding power, or absolute hiding power.

Returning to FIG. 2, preferably the diffuser sheet 14 has little or no light-scattering particles, as the diffusion function is performed by optical structures 40. Conventional diffuser sheets often use only light-scattering particles to provide a desired hiding power. Light scattered in such diffuser sheets with a high density of light scattering particles undergo multiple scattering events, meaning that a light ray sees an extremely long path traveling through such a sheet and thus a significant amount of light gets absorbed in the sheet. In a typical diffuser sheet, 10% of the light is absorbed per pass. If a prism film is placed above such a sheet, it recycles some of the light back down through the diffuser sheet, where it bounces off of the reflector and passes back up through the diffuser sheet, losing 10% on both passes. This greatly reduces efficiency of such recycling film stacks. Thus, preferably the diffuser sheet 14 has little or no light-scattering particles to perform diffusion function, where that function is instead performed by optical structures 40 resulting in less light absorption by the diffuser sheet 14.

FIG. 2 illustrates the optical structures 40 to be convex structures with a half cylinder cross-section. The optical structures 40, however, may have a number of different shapes. For example, FIG. 4 illustrates a diffuser sheet 14 where the optical structures 40 are convex structures with a sinusoidal wave cross-section. The optical structures 40 may also be concave structures such as concave structures with a half cylinder cross-section, or a sinusoidal wave cross-section. The optical structures 40 should be such, however, to provide both an optical diffusion function as well as an optical light direction function. Here diffusion can be considered any light spreading or lensing effect whether achieved through reflection (including total internal reflection), refraction, diffraction or any combination thereof. Also, since prismatic surfaces result in image splitting that modifies the hiding power they also provide a diffusion function as well as a light redirection function.

FIG. 5 illustrates an embodiment of the diffuser sheet 14 where both sides of the sheet have optical structures 40. The optical structures for both sides may have a number of different shapes in the same fashion as for embodiments where only one side of the diffuser sheet 14 contains optical structures 40. FIG. 5 shows an arrangement where optical structures 40 on opposing sides of the diffuser sheet 14 are arranged to run perpendicular to each other.

If the diffuser sheet is incorporated in a display assembly with other optical components having a regular structure, such as a prism film with regularly spaced prism structures, interference Moire effects may results. These Moire effects may be reduced by randomizing the idealized structure of the optical structures 40. Reducing Moire effects by randomizing an idealized structure of an optical structure is disclosed, for example, in U.S. Pat. No. 6,862,141 to Eugene Olczak, issued on Mar. 1, 2005, which discloses modulating an idealized prism structure of an optical substrate from a nominal linear path in a lateral direction (direction perpendicular to the height) by applying a nonrandom, random (or pseudo random) amplitude and period texture. The disclosure of U.S. Pat. No. 6,862,141 is incorporated herein by reference in its entirety.

FIG. 6 illustrates a cross section of a diffuser sheet 14 with idealized optical structures 40 characterized by a peak height h, and pitch p (distance between optical structures). The shape and dimensions of the idealized structure 40 may be randomized such that a shape and dimensions of each optical structure represents a random modulation of a corresponding idealized structure. For example, the height h and/or the pitch p may be randomly varied. Also the variations may be applied as a constant bias per structure or may vary along the length of the structure over a range of wavelengths and amplitudes.

In general the height, pitch and wavelengths may be in a range between 100 nanometers and 10 millimeters. The cross section of each structure may be concave, convex, sinusoidal, or triangular (prismatic), for example. The cross section might also be a piecewise assembly of these geometries or any other useful shape including diffractive micro structures and nano structures. The size of the diffuser sheet and/or the display in which the diffuser sheet is used may be in the range of one millimeter by one millimeter to several meters by several meters. The thickness may vary between 12 microns and 25 millimeters. Each and every parameter may be held constant or varied as described above. Additionally the parameters may be designed to incorporate desirable ratios between parameters (for example the relative pitch of one structure to another or the relative pitch of one structure to the LCD pixel pitch).

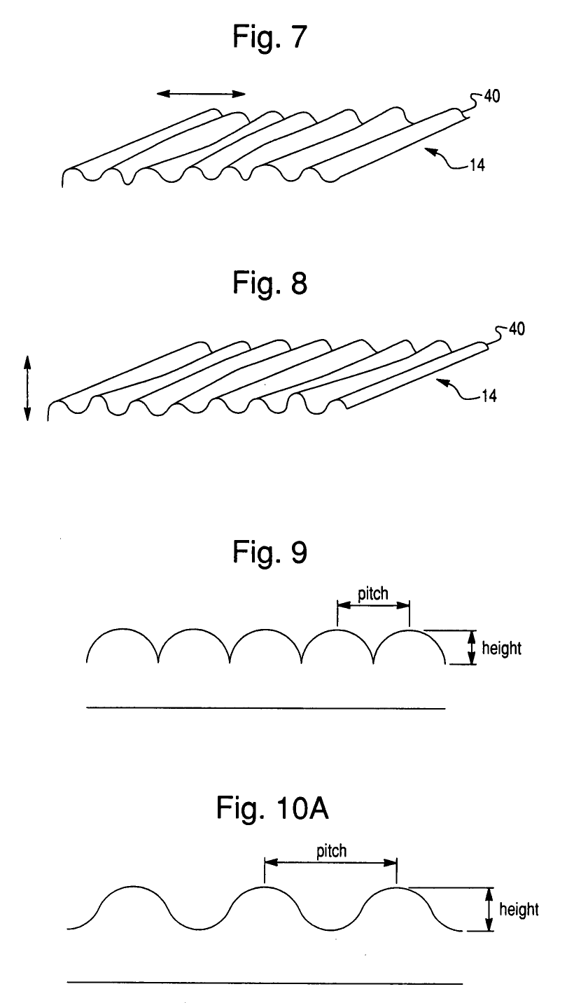

FIG. 7 illustrates a diffuser sheet 14 where the optical structures 40 have some random modulation in a lateral direction, such as in the pitch, while FIG. 8 illustrates a diffuser sheet 14 where the optical structures 40 have some random modulation in direction perpendicular to the lateral direction, such as in the height.

The random modulation in a direction perpendicular to the lateral direction, such as shown in FIG. 8, in addition to reducing Moire effects, can also reduce optical coupling between the diffuser sheet 14 and any films arranged adjacent to the optical structures 40. This is so because the region of the diffuser sheet 14 which contacts the adjacent sheet is reduced, because the number of contact points between the diffuser sheet and the adjacent sheet is reduced by random modulation in a direction perpendicular to the lateral direction.

### Diffuser Sheet Examples

Table 1 illustrates examples of diffuser sheets according to embodiments of the invention along with two comparative examples DS and DS2. The values were calculated using an optical model validated through experimental results. The optical model is based on a geometric ray-tracing program that uses a Monte Carlo geometric ray tracing technique. Error bars on the result represent one standard deviation of the Monte Carlo error. The parameter values used by the optical model are for a typical 26″ direct-lit BLM. The optical model assumes that the bulbs and the reflector in the BLM absorb 6% of the light rays intersecting them and isotropically reflects the remaining 94%. The input parameters for the detector system include the spot size of 2 mm at the top of the film stack. The detector is located at 55 mm distance from the top of the film stack. For on-bulb measurements, the detector is positioned directly over top of the bulb when at zero degrees zenith. For the off-bulb measurements the detector is position between the bulbs. The rays (i.e. photons) fired by the Monte Carlo geometric ray tracing software program each have one unit of dimensionless energy. The software program figures out how much of the energy is absorbed and finally how much energy is emitted and in what direction. The dimensionless ray energy from the model is multiplied by a coefficient that converts it to luminance units of cd/m². The calculation results from the models were validated against experimental measurements.

TABLE 1
Diffuser sheets

| | | | Particle | Total | Total | | Sheet Only |
|---|---|---|---|---|---|---|---|
| Diffuser | Bottom | Top | Concentration | Transmission | Reflection | Absorption | Hiding |
| Sheet | Texture | Texture | (pph) | (%) | (%) | (%) | Power |
| 1. DS | Smooth | Smooth | 0.5 | 58.03 | 32.89 | 9.08 | −0.5 ± 0.6 |
| 2. DS2 | Smooth | Smooth | 0.125 | 79.12 | 15.6 | 5.28 | −28.7 ± 0.7 |
| 3. STDP-A | Smooth | Texture A | 0.125 | 60.88 | 32.44 | 6.68 | −8.2 ± 0.9 |
| 4. STDP-B | Smooth | Texture B | 0.125 | 64.21 | 28.77 | 7.02 | −6.3 ± 1.0 |
| 5. STDP-C | Smooth | Texture C | 0.125 | 70.53 | 22.78 | 6.69 | −6.4 ± 1.4 |
| 6. DTDP-A | Texture A | Texture A | 0 | 61.38 | 36.78 | 1.84 | −4.1 ± 1.0 |
| 7. DTDP-B | Texture B | Texture B | 0 | 71.34 | 26.77 | 1.89 | −2.6 ± 1.1 |

DS and DS2 are volumetric scattering diffuser sheets made of 2 mm thick polycarbonate. All diffuser sheets are 2 mm in thickness. Particle concentration is in parts per hundred (pph). The particles have a 2 micron diameter and are composed of hydrolyzed poly(alkyl trialkoxysilanes) available under the trade name TOSPEARL™ from GE Silicones. The based material for all the sheets is polycarbonate.

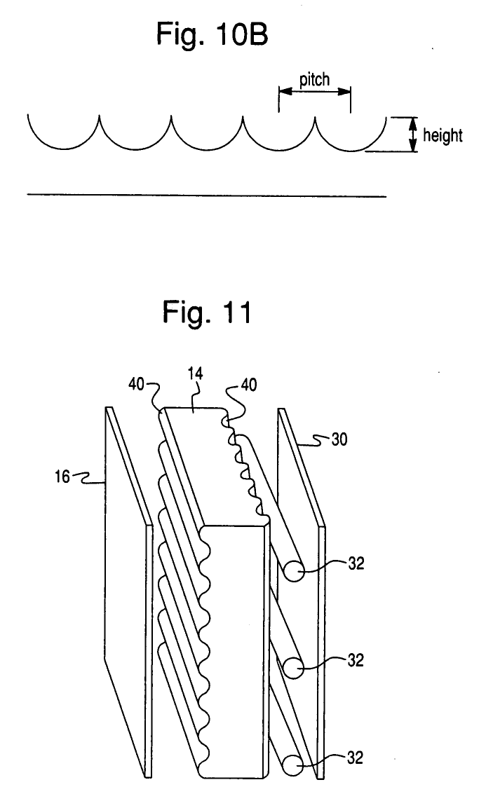

The bottom texture is the side of the diffuser sheet facing the light sources. The top texture is the side of the diffuser sheet facing the viewer (or detector). The three textures, labeled Texture A, Texture B, and Texture C are shown in FIGS. 9, 10A and 10B, respectively, and are a convex half cylinder, a sinusoidal wave, and a concave half cylinder texture, respectively. The pitch, distance between adjacent peaks or valleys, of the textures was between 5 and 200 microns. The aspect ratio, the ratio of the height of the features to the pitch, was between 0.2 and 1.0, and preferably between 0.4 and 0.5. The total transmission, reflection, and absorption are calculated using the validated optical model, and a geometric ray tracing software program.

STDP-A, STDP-B, and STDP-C, are diffuser sheets with one smooth side, and one textured side. The textured side for diffuser sheets STDP-A, STDP-B, and STDP-C have texture A, texture B and texture C, respectively, as those textures are shown in FIGS. 9, 10A, and 10B. DTDP-A and DTDP-B are diffuser sheets with textured sides on both sides of the diffuser sheet, where the optical structures on opposing sides of the diffuser sheet are arranged to run perpendicular to each other. Diffuser sheets DTDP-A and DTDP-B have texture A and texture B, respectively, as those textures are shown in FIGS. 9 and 10A.

Table 1 shows the reduction in absorption of the diffuser sheet for the single sided textures STDP-A, STDP-B and STDP-C (˜7%) as compared to a smooth surface diffuser sheet with a greater concentration of particles (˜9%). Table 1 also shows the reduction in absorption of the diffuser sheet for the double sided textures DTDP-A, DTDP-B (˜2%) as compared to a smooth surface diffuser sheet with a greater concentration of particles (˜9%).

Moreover, while the smooth diffuser plate with lower particle concentration, DS2, has an absorption less than ˜9%, it exhibits a significant loss in bulb hiding power for the smooth texture and at the equivalent of 0.125 pph particles as compared to the single texture diffuser sheets (texture A, B or C) with 0.125 pph particles.

### Optical Display Assembly Using Diffuser Sheet

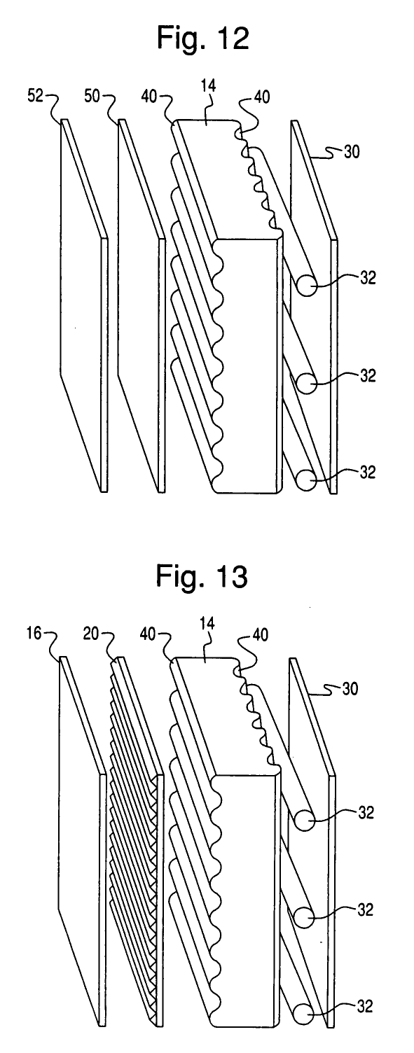

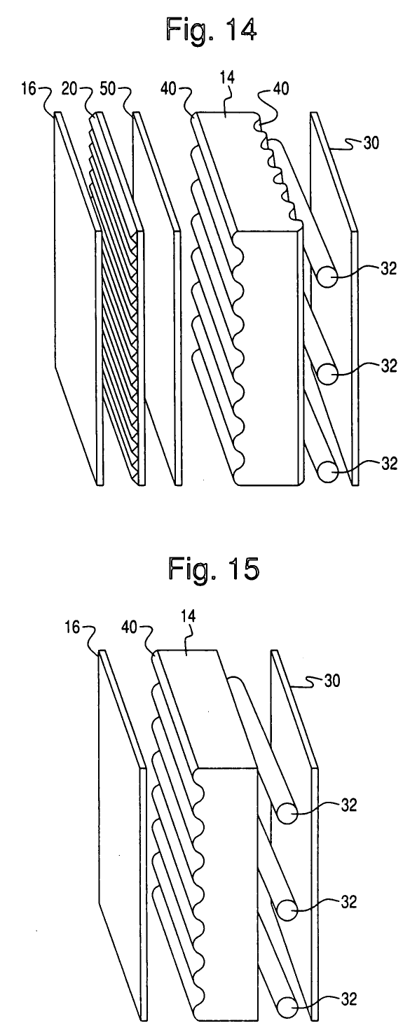

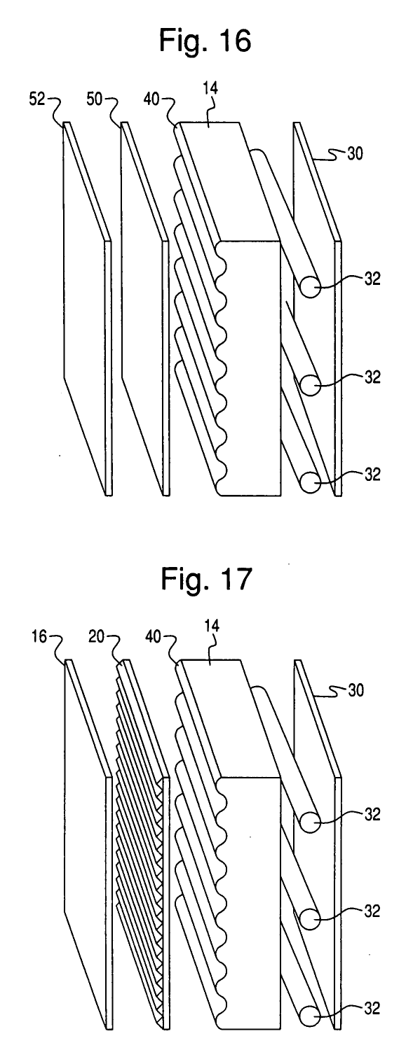

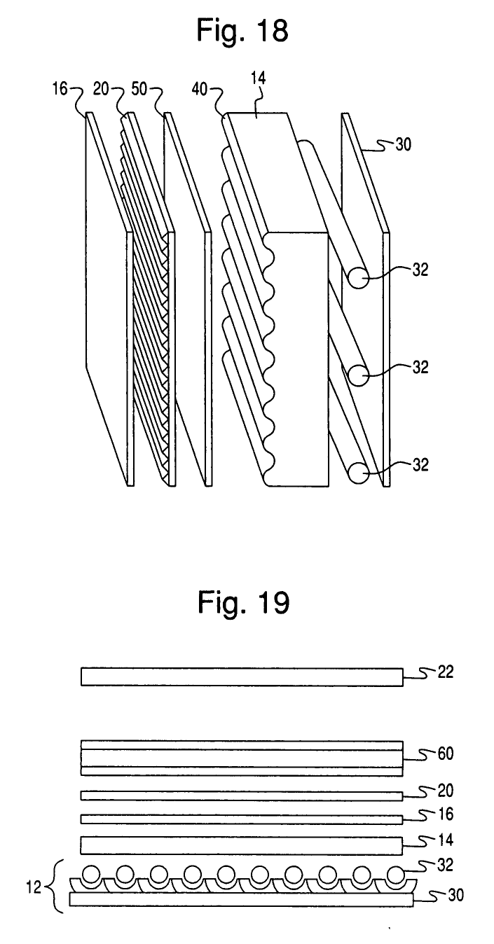

In addition to the optical display assembly illustrated in FIG. 1, the diffuser sheet 14 may be used in a number of different arrangements as illustrated hereafter. FIGS. 11-18 illustrate embodiments with various arrangements of the diffuser sheet 14, reflector 30, light sources 32, and variations of the optical films: diffuser film 16, diffuser film 18, light collimating diffuser film 50, and light collimating diffuser film 52. FIGS. 11-14 illustrate embodiments where the optical structures 40 are on both sides of the diffuser sheet 14, while FIGS. 15-18 illustrate embodiments where the optical structures 40 are on only one side of the diffuser sheet 14.

FIG. 19 illustrates an embodiment of the optical display assembly with diffuser sheet 14, including a recycling polarizer 60. The recycling polarizer is arranged above the diffuser sheet 14, diffuser film 16, and prism film 20, and below the liquid crystal 22. The reflective polarizer reflects some polarized light (e.g., light that is not in the correct direction to be received by the liquid crystal 22), while transmitting other polarized light. Other optical films that do not significantly depolarize light may be arranged between the recycling polarizer 60 and the liquid crystal. In some cases, it is possible for some textured films, such as prism films, to allow polarized light to be transmitted without significantly reducing the degree of light polarization even if they change the direction of polarization or transform the polarization state as defined for example by the Jones Matrix of the polarized component of optical field (The polarized and unpolarized components together comprise the more general Mueller Matrix). Thus it is possible to arrange the light recycling polarizer just below the LCD panel and those films that don't depolarize the light, but above the depolarizing diffuser films.

In some cases it may be desirable to tune the diffuser sheet, diffuser films or other components to provide an intentional transformation of the degree of polarization or polarization state to aid in more efficient polarization recycling or other display performance enhancements.

### Performance of Optical Display Assembly Including Diffuser Sheet

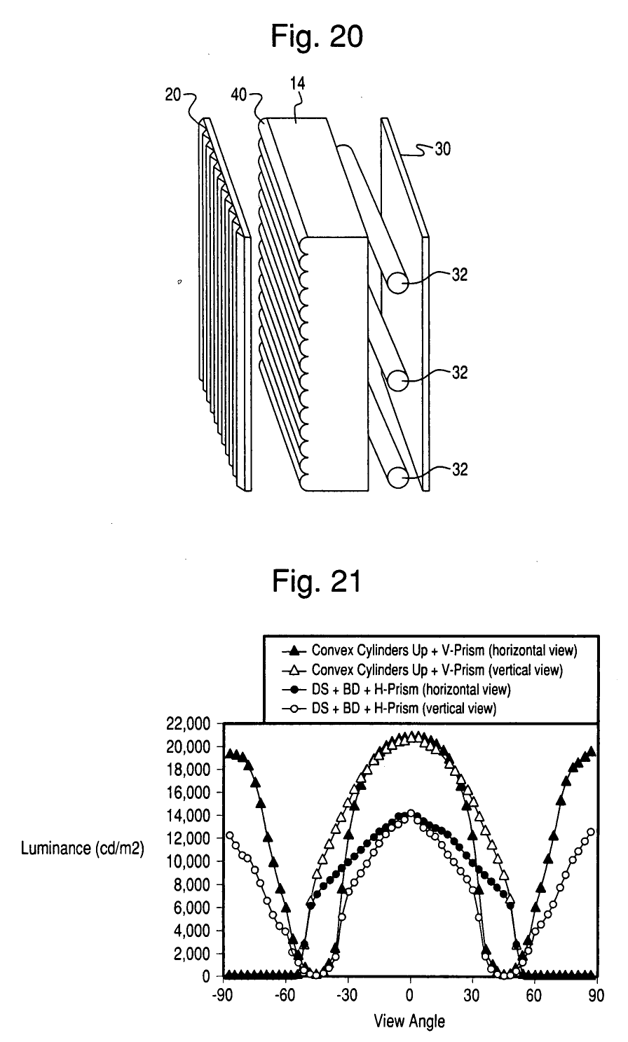

The performance of optical display assemblies including the diffuser sheet was calculated using the validated optical model. FIG. 20 illustrates one optical display assembly configuration for which the performance was calculated. The optical display assembly of FIG. 20 includes light provider 12 with CCFL light sources 32 and reflector 30, optical diffuser sheet 14 with optical structures 40, diffuser film 16 and prism film 20. The vertical view luminance was calculated as a function of vertical zenith angle, and the horizontal view luminance was calculated as a function of horizontal zenith angle for the arrangement shown in FIG. 20.

The results of the calculation are shown in FIG. 21. In addition to the horizontal view luminance and vertical view luminance for the display assembly shown in FIG. 20, FIG. 21 also shows horizontal view luminance and vertical view luminance for the case where an optical diffuser film 61 is added to the assembly. As can be seen, the configuration including the diffuser sheet 14 provides improved on-axis luminance. Note however the horizontal view is more narrow than the vertical view. If the light bulbs were oriented in a vertical direction rather than the horizontal, this device would then have a broader horizontal view.

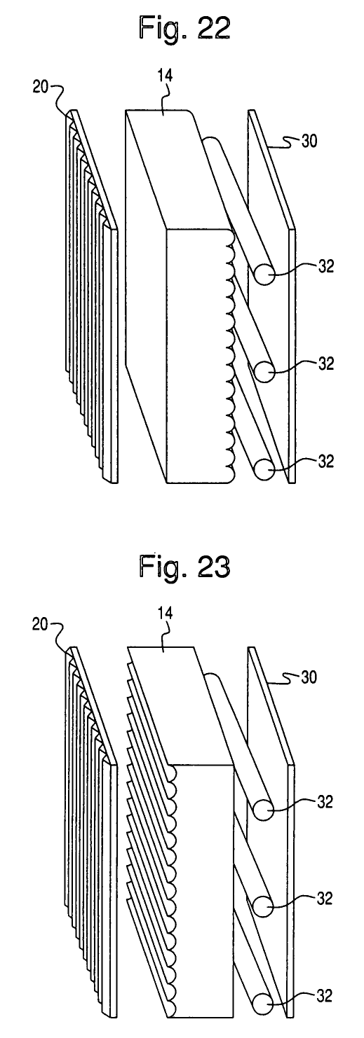

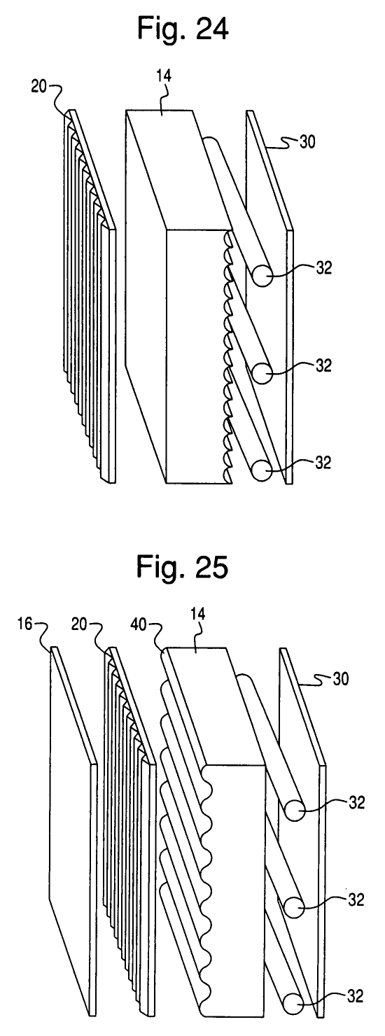

FIG. 20 illustrates a configuration where the optical diffuser sheet 14 has optical structures 40 on only one side, where the optical structures 40 are convex half cylinder structures arranged on the side opposite the CCFL light sources 32. The vertical and horizontal view luminance as a function of zenith angle was also calculated for the optical display assembly configurations as shown in FIGS. 22-24. In the FIG. 22, the optical structures 40 are convex half cylinder structures arranged on the side facing the CCFL light sources 32. In the FIG. 23, the optical structures 40 are concave half cylinder structures arranged on the side facing the CCFL light sources 32. In the FIG. 24, the optical structures 40 are concave half cylinder structures arranged on the side opposite the CCFL light sources 32.

FIG. 25 illustrates another configuration where the diffuser film 16 is arranged above the prism film 20, and the optical structures 40 are convex sinusoidal wave structures arranged on the side opposite the CCFL light sources 32. In the configuration of FIG. 25, the optical structures 40 are arranged in the same direction as the CCFL light sources 32 (horizontal direction), and the prisms of the prism film are arranged in a direction perpendicular (vertical direction) to the direction of the CCFL light sources 32.

The optical diffuser sheets 14 in FIGS. 20 and 22-25 do not have any light scattering particles, and are textured polycarbonate films.

Table 2 lists the luminance, and full width half maxima (FWHM) of both the horizontal view luminance and vertical view luminance of the arrangements of FIGS. 20 and 22-25, where FIG. 20 is convex cylinders up, FIG. 22 is convex cylinders down, FIG. 23 is concave cylinders down, FIG. 24 is concave cylinders up, and FIG. 25 is sinusoidal wave. The orientation of the optical structures 40 are in a horizontal direction, parallel to the orientation of the CCFL light sources 32. The prisms are vertical in orientation for FIGS. 20, 22, 23, 24 and 25. The diffuser film 16 in FIG. 25 has 95% transmission haze.

TABLE 2
Performance of optical display assembly configurations

| | | Horizontal | Vertical | Bulb |
|---|---|---|---|---|
| Film Stack | Luminance | View | View | Hiding |
| Description | (cd/m²) | (FWHM) | (FWHM) | Power % |
| 8. convex | 21,011 ± 96 | 61.1 | 82.4 | 1.6 ± 0.6 |
| cylinders up | | | | |
| 9. convex cylinders | 16,215 ± 165 | 64.3 | 98.4 | −4.6 ± 1.4 |
| down | | | | |
| 10. concave | 16,391 ± 333 | 63.1 | 97.7 | −9.9 ± 2.9 |
| cylinders down | | | | |
| 11. concave | 20,130 ± 409 | 60.8 | 97.2 | −0.5 ± 2.9 |
| cylinders up | | | | |
| 12. sinusoidal wave | 17,621 ± 253 | 58.2 | 71.4 | −0.0 ± 2.0 |

The results are shown in Table 2. The luminance shown is the on-axis luminance. Also shown in Table 2 is the full width half maxima for both the horizontal view and the vertical view.

TABLE 3
Performance of Single and Double Textured Diffuser Plates

| | | Horizontal | Vertical | |
|---|---|---|---|---|
| | | View | View | Bulb Hiding |
| Film Stack Description | Luminance (cd/m²) | (FWHM) | (FWHM) | Power % |
| 13. STDP-A | 9,638 ± 63 | 139.2 | 90.1 | −8.2 ± 0.9 |
| 14. STDP-B | 9,541 ± 66 | 139 | 93.8 | −6.3 ± 1.0 |
| 15. STDP-C | 9,046 ± 87 | 141.3 | 133.1 | −6.4 ± 1.4 |
| 16. STDP-B + BD | 11,585 ± 89 | 79.4 | 77.8 | −3.0 ± 1.1 |
| 17. STDP-C + BD | 11,249 ± 126 | 80.5 | 81.0 | −3.2 ± 1.6 |
| 18. STDP-B + BD + BD | 12,727 ± 98 | 67.4 | 67.4 | −1.0 ± 1.1 |
| 19. STDP-C + BD + BD | 12,566 ± 135 | 69.1 | 68.6 | −1.5 ± 1.5 |
| 20. STDP-B + Prism | 14,509 ± 132 | 96.4 | 63.3 | 1.5 ± 1.3 |
| 21. STDP-C + Prism | 13,505 ± 127 | 98.1 | 66.4 | 0.8 ± 1.3 |
| 22. STDP-B + BD + Prism | 14,729 ± 92 | 88.3 | 60.7 | 1.2 ± 0.9 |
| 23. STDP-C + BD + Prism | 14,737 ± 97 | 88.9 | 60.4 | −0.1 ± 0.9 |
| 24. DTDP-A | 10,051 ± 72 | 159.4 | 91.7 | −4.1 ± 1.0 |
| 25. DTDP-B | 9,766 ± 79 | 159.1 | 85.8 | −2.6 ± 1.1 |
| 26. DTDP-A + BD | 13,627 ± 196 | 85.4 | 72.7 | −1.5 ± 2.0 |
| 27. DTDP-B + BD | 12,571 ± 136 | 85.8 | 77.1 | −0.9 ± 1.5 |
| 28. DTDP-A + BD + BD | 16,405 ± 236 | 70.4 | 66.6 | 0.1 ± 2.0 |
| 29. DTDP-B + BD + BD | 15309 ± 116 | 71.0 | 67.8 | −2.6 ± 1.1 |
| 30. DTDP-A + Prism | 17,524 ± 252 | 97.8 | 62.6 | 1.4 ± 2.0 |
| 31. DTDP-B + Prism | 17,690 ± 147 | 97 | 63 | −4.3 ± 1.2 |
| 32. DTDP-A + BD + Prism | 19,898 ± 286 | 91 | 61.7 | 0.6 ± 2.0 |
| 33. DTDP-B + BD + Prism | 19,276 ± 165 | 91.9 | 61.4 | 1.0 ± 1.2 |

The film stack description in Table 3 lists the components of the assembly in order from the component just above the CCFL light sources 32 to the component at the top of the stack. STDP-A, STDP-B, STDP-C, are diffuser sheets with one smooth side, and one textured side. The textured side for diffuser sheets STDP-A, STDP-B, STDP-C have texture A, texture B and texture C, respectively, as those textures are shown in FIGS. 9, 10A, and 10B, respectively. DTDP-A and DTDP-B are diffuser sheets with textured sides on both sides of the diffuser sheet. Diffuser sheets DTDP-A and DTDP-B have texture A and texture B, respectively, as those textures are shown in FIGS. 9 and 10A. BD is a light collimating diffuser film composed of 0.125 mm thick poly(ethylene terephthalate) with micro lens texture on a side facing viewer (detector), i.e., on a side away from the light provider. Prism is a horizontally oriented (prisms are parallel to the CCFL light sources) prism film composed of 0.125 mm thick poly(ethylene terephthalate) having a texture coating with an array of straight prisms having a 50 micron pitch and 25 micron height.

The luminance shown in Table 3 is the on-axis luminance. Also shown in Table 3 is the full width half maxima for both the horizontal view and the vertical view, and the bulb hiding power. As can be seen from the results in Table 3, the diffuser sheets provide good hiding power, and light collimation for the vertical view, as well as good on-axis luminance.

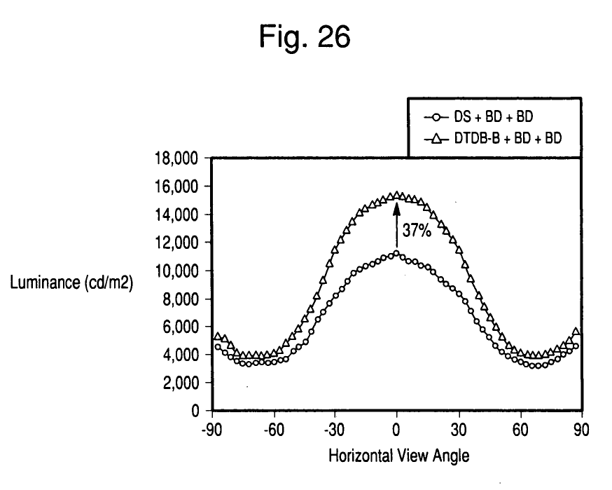

FIG. 26 provides a comparison of the luminance as a function of the horizontal zenith angle for a stack of optical components, in order, of DS+BD+BD with a stack of DTDP-B+BD+BD, where the components DS, BD and DTDP-B are as defined above. As can be seen there is a 37% increase in the on-axis luminance for the stack with the diffuser sheet DTDP-B, as compared to the one with the diffuser film DS.

As described above, the diffuser sheet can be used with diffuser films and/or prismatic films to provide various output distributions of light. These embodiments can increase the total output of light by more than 10%. On-axis luminance may be increased by 10-100%, depending on the specific combinations of microstructures and films. This enables a variety of designs to meet specific light-output requirements of a given display model, all of which are much brighter than conventional designs.

The light management film stacks for direct-lit display backlighting described above offer improved luminous efficiency. An important component is a low-absorption diffuser sheet, which can be used with diffuser films, prismatic films, or combinations thereof, that offers hiding power comparable to conventional diffuser sheets but higher on-axis luminance, improved luminance over wider view angles, improved total light throughput, and in some embodiments fewer optical components.

Small amounts of light-scattering particles could be added to the diffuser sheet to improve hiding power, depending on the design objectives for a specific backlight.

While the invention has been described with reference to several embodiments thereof, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims.

What is claimed is:

1. An optical diffuser sheet, comprising:
a first surface having a plurality of optical structures arranged to diffuse and direct light illuminated onto the first surface, wherein the optical structures have a concave cross-section; and
a second surface opposite to the first surface.

2. The optical diffuser sheet of claim 1, wherein the second surface has a plurality of optical structures arranged to diffuse and direct light illuminated onto the second surface.

3. An optical diffuser sheet, comprising:
a first surface having a plurality of optical structures arranged to diffuse and direct light illuminated onto the first surface, wherein the optical structures have a sinusoidal wave cross-section; and
a second surface opposite to the first surface.

4. The optical diffuser sheet of claim 3, wherein the second surface has a plurality of optical structures arranged to diffuse and direct light illuminated onto the second surface.

5. An optical diffuser sheet, comprising:
a first surface having a plurality of optical structures arranged to diffuse and direct light illuminated onto the first surface, wherein a shape and dimensions of each optical structure represents a random modulation of a corresponding idealized structure; and
a second surface opposite to the first surface.

6. The optical diffuser sheet of claim 5, wherein the second surface has a plurality of optical structures arranged to diffuse and direct light illuminated onto the second surface.

7. The optical diffuser sheet of claim 5, wherein the shape and dimensions of each optical structure represents a random modulation of a corresponding idealized structure in a lateral direction.

8. The optical diffuser sheet of claim 5, wherein the shape and dimensions of each optical structure represents a random modulation of a corresponding idealized structure in a vertical direction.

9. An optical diffuser sheet, comprising:
a first surface having a plurality of optical structures arranged to diffuse and direct light illuminated onto the first surface; and
a second surface opposite to the first surface,
wherein the optical diffuser sheet when illuminated is characterized by an absorption of less than 10% and an absolute hiding power of less than 10%.

10. The optical diffuser sheet of claim 9, wherein the optical diffuser sheet when illuminated is characterized by an absorption of less than 7% and an absolute hiding power of less than 7%.

11. The optical diffuser sheet of claim 10, wherein the optical diffuser sheet when illuminated is characterized by an absorption of less than 4% and an absolute hiding power of less than 4%.

12. The optical diffuser sheet of claim 9, wherein the optical structures have one of a half cylinder cross-section or a sinusoidal wave cross-section.

13. The optical diffuser sheet of claim 9, wherein the second surface has a plurality of optical structures arranged to diffuse and direct light illuminated onto the second surface.

14. The optical diffuser sheet of claim 9, wherein the optical diffuser sheet has a density of light scattering particles to provide light diffusion.

15. An optical display assembly comprising:
a light provider comprising a plurality of light sources;
an optical diffuser sheet comprising:
a first surface having a plurality of optical structures arranged to diffuse and direct light illuminated onto the first surface from the light provider; and
a second surface opposite to the first surface; and
a diffuser film over the light provider and optical diffuser sheet, arranged to receive light from the optical diffuser sheet, the diffuser film having a density of light scattering particles to provide light diffusion and/or a rough surface to provide light diffusion.

16. The optical display assembly of claim 15, wherein the plurality of light sources comprise a plurality of lamps arranged to run in a horizontal direction parallel to each other.

17. An optical display assembly comprising:
a light provider comprising a plurality of light sources;
an optical diffuser sheet comprising:
a first surface having a plurality of optical structures arranged to diffuse and direct light illuminated onto the first surface from the light provider, wherein a shape and dimensions of each optical structure represents a random modulation of a corresponding idealized structure in a vertical direction; and
a second surface opposite to the first surface; and
an optical film arranged on the optical diffuser sheet adjacent to the first surface.

18. The optical display assembly of claim 17, further comprising:
a light recycling polarizer arranged above the optical film.

19. An optical display assembly comprising:
a light provider comprising a plurality of light sources;
a first optical diffuser sheet comprising:
a first surface having a plurality of optical structures arranged to diffuse and direct light illuminated onto the first surface from the light provider; and
a second surface opposite to the first surface, and having a plurality of optical structures arranged to diffuse and direct light illuminated onto the second surface; and
a second optical diffuser sheet arranged above the first optical diffuser sheet comprising:
a third surface having a plurality of optical structures arranged to diffuse and direct light illuminated onto the third surface; and
a fourth surface opposite to the third surface.

20. An optical display assembly comprising:
a light provider comprising a plurality of light sources;
an optical diffuser sheet comprising:
a first surface having a plurality of optical structures arranged to diffuse and direct light illuminated onto the first surface from the light provider; and
a second surface opposite to the first surface, and having a plurality of optical structures arranged to diffuse and direct light illuminated onto the second surface; and
a light collimating diffuser film arranged above the optical diffuser sheet.

21. The optical display assembly of claim 20, further comprising:
a light recycling polarizer arranged above the light collimating diffuser film.

22. The optical display assembly of claim 20, further comprising:
a second light collimating diffuser film arranged above the light collimating diffuser film.

23. The optical display assembly of claim 22, further comprising:
a third light collimating diffuser film arranged above the second light collimating diffuser film.

24. The optical display assembly of claim 20, further comprising:
a prism film arranged between the light collimating diffuser film and the optical diffuser sheet.

25. The optical display assembly of claim 24 further comprising:
a second light collimating diffuser film arranged above the prism film.

26. The optical display assembly of claim 20, further comprising:
a prism film arranged above the light collimating diffuser film and the optical diffuser sheet.

27. An optical display assembly comprising:
a light provider comprising a plurality of light sources;
an optical diffuser sheet comprising:
a first surface having a plurality of optical structures arranged to diffuse and direct light illuminated onto the first surface from the light provider; and
a second surface opposite to the first surface; and
a light collimating diffuser film arranged above the optical diffuser sheet.

28. The optical display assembly of claim 27, further comprising:
a second light collimating diffuser film arranged above the light collimating diffuser film.

29. The optical display assembly of claim 28, further comprising:
a third light collimating diffuser film arranged above the second light collimating diffuser film.

30. The optical display assembly of claim 27, further comprising:
a prism film arranged between the light collimating diffuser film and the optical diffuser sheet.

31. The optical display assembly of claim 30, further comprising:
a second light collimating diffuser film arranged above the prism film.

32. The optical display assembly of claim 27, further comprising:
a light recycling polarizer arranged above the light collimating diffuser film.

33. The optical display assembly of claim 27, further comprising:
a prism film arranged above the light collimating diffuser film and the optical diffuser sheet.
